(19) United States
(12) Patent Application Publication
(10) Pub. No.: US 2014/0146267 A1
(43) Pub. Date: May 29, 2014

(54) LIQUID CRYSTAL MODULE AND LIQUID CRYSTAL DISPLAY DEVICE

(71) Applicant: Shenzhen China Star Optoelectronics Technology Co. Ltd., Shenzhen, Guangdong (CN)

(72) Inventor: Chong Huang, Shenzhen (CN)

(73) Assignee: Shenzhen China Star Optoelectronics Technology Co. Ltd., Shenzhen, Guangdong (CN)

(21) Appl. No.: 13/806,975

(22) PCT Filed: Dec. 4, 2012
(86) PCT No.: PCT/CN12/85866

§ 371 Date: Dec. 26, 2012

(30) Foreign Application Priority Data
Nov. 28, 2012 (CN) 201210493950.3

(51) Int. Cl. F21V 8/00; G02F 1/1333

(52) U.S. Cl. CPC G02B 6/0085; G02F 1/133385
USPC 349/58

(57) ABSTRACT

The present invention provides a liquid crystal module, which includes an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source. The present invention further provides a liquid crystal display device. The present invention disposes a heat-dissipation layer formed by radiation heat-dissipation material on the outer surface of the front frame near the edge-lit backlight source and uses the radiation heat-dissipation to greatly enhance the heat-dissipation capability of the front frame and improve the overall heat-dissipation result of the liquid crystal module and the liquid crystal display device.

The present application claims priority of “LIQUID CRYSTAL MODULE AND LIQUID CRYSTAL DISPLAY DEVICE”, application number 201210493950.3 submitted to State Intellectual Property Office, People Republic of China dated Nov. 28, 2012.

### BACKGROUND OF THE INVENTION

1. Field of the Invention

The present invention relates to the field of image displaying techniques, and in particular to a liquid crystal module and liquid crystal display device.

2. The Related Arts

The known thin film transistor liquid crystal display (TFT-LCD) mainly use LED backlight, with the advantages of reduced thickness, light weight, and low power consumption to meet the increasing design demands. The main stream design uses edge-lit design.

Because LED generates heat. To ensure light efficiency and life-span of LED, a heat-dissipation design is required for LED. FIG. 1 is a schematic view showing LED heat-dissipation path of a known liquid crystal display device. The known heat-dissipation design is mainly conductive heat-dissipation. In other words, the heat form LED light 1i conducted to a backplane 3. The backplane is made of material, such as metal, with good heat-dissipation capability. Through analysis of the known LED heat-dissipation path, some of the heat is shown to be conducted to a front frame 5 in a direction shown as the arrow in FIG. 1. However, the front frame 5 is usually made of plastic or electro-galvanized steel (SECC) having poor heat-dissipation capability and unable to dissipate the heat in time, which affects the quality of the liquid crystal display device.

### SUMMARY OF THE INVENTION

The technical issue to be addressed by the present invention is to provide a liquid crystal module and liquid crystal display device, to enhance the heat-dissipation capability of a front frame.

The present invention provides a liquid crystal module, which comprises: an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source.

According to a preferred embodiment of the present invention, the outer surface of the front frame comprises a first surface parallel to the incident surface of the light-guiding plate, and a second surface perpendicular to the incident surface of the light-guiding plate.

According to a preferred embodiment of the present invention, the heat-dissipation layer is a radiation heat-dissipation material layer.

According to a preferred embodiment of the present invention, the heat-dissipation layer has a thickness of 0.02-0.06 mm.

According to a preferred embodiment of the present invention, the backplane is disposed with a heat-dissipation layer at bottom.

According to a preferred embodiment of the present invention, the radiation heat-dissipation material layer is deposited with one or any combination of carbon nanotubes, electronic transitions spinel, and rare earth oxide.

According to a preferred embodiment of the present invention, the radiation heat-dissipation material layer is a heat-dissipation paint.

According to a preferred embodiment of the present invention, the heat-dissipation paint is a soft ceramic heat-dissipation paint.

The present invention provides a liquid crystal module, which comprises: an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source; the outer surface of the front frame comprising a first surface parallel to the incident surface of the light-guiding plate, and a second surface perpendicular to the incident surface of the light-guiding plate.

The present invention provides a liquid crystal display device, which comprises: a liquid crystal module, the liquid crystal module further comprising: an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source.

According to a preferred embodiment of the present invention, the outer surface of the front frame comprises a first surface parallel to the incident surface of the light-guiding plate, and a second surface perpendicular to the incident surface of the light-guiding plate.

According to a preferred embodiment of the present invention, the heat-dissipation layer is a radiation heat-dissipation material layer.

According to a preferred embodiment of the present invention, the heat-dissipation layer has a thickness of 0.02-0.06 mm.

According to a preferred embodiment of the present invention, the backplane is disposed with a heat-dissipation layer at bottom.

According to a preferred embodiment of the present invention, the radiation heat-dissipation material layer is deposited with one or any combination of carbon nanotubes, electronic transitions spinel, and rare earth oxide.

According to a preferred embodiment of the present invention, the radiation heat-dissipation material layer is a heat-dissipation paint.

According to a preferred embodiment of the present invention, the heat-dissipation paint is a soft ceramic heat-dissipation paint.

The efficacy of the present invention is that to be distinguished from the state of the art. The liquid crystal module and the liquid crystal display device of the present invention disposes a heat-dissipation layer formed by radiation heat-dissipation material on the outer surface of the front frame near the edge-lit backlight source and uses the radiation heat-dissipation to greatly enhance the heat-dissipation capability of the front frame and improve the overall heat-dissipation result of the liquid crystal module and the liquid crystal display device.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing LED heat-dissipation path of a known liquid crystal display device;

FIG. 2 is a schematic view showing the cross-section of the first embodiment of the liquid crystal module according to the present invention;

FIG. 3 is a schematic view showing LED heat-dissipation path of the liquid crystal module shown in FIG. 2; and

FIG. 4 is a schematic view showing another the heat-dissipation path of the first embodiment of the liquid crystal module according to the present invention.

### DETAILED DESCRIPTION OF THE PREFERRED EMBODIMENTS

The following refers to the drawing to describe the preferred embodiments of the present invention.

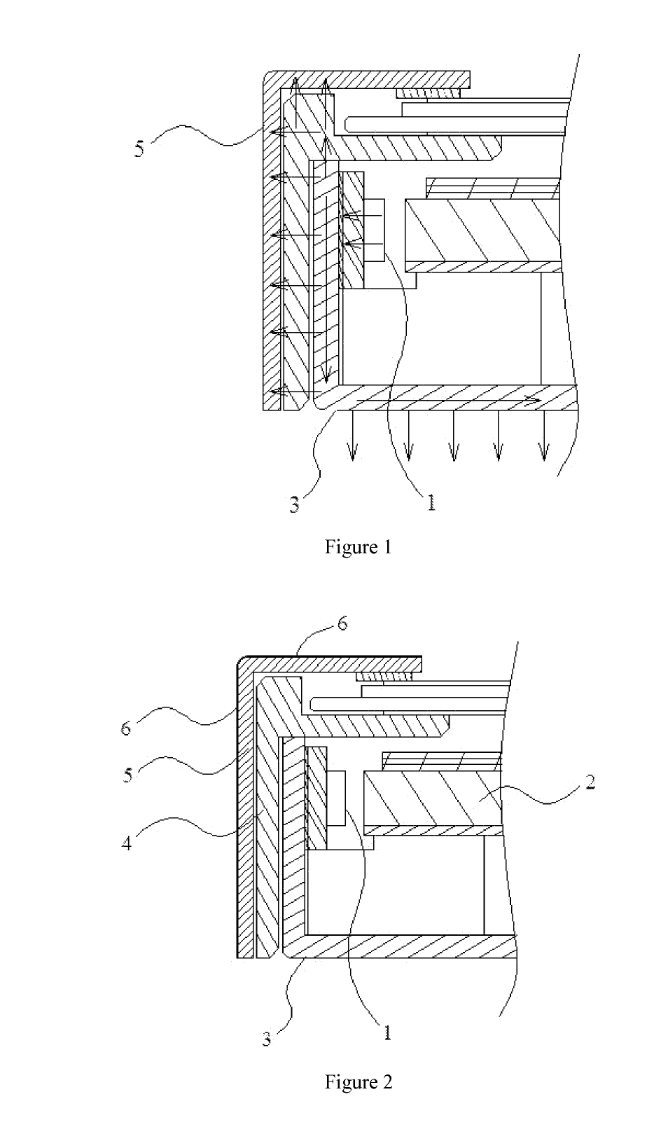

Referring to FIG. 2, FIG. 2 is a schematic view showing the cross-section of the first embodiment of the liquid crystal module according to the present invention. The liquid crystal module comprises: an edge-lit backlight source 1; a light-guiding plate 2, having an incident surface and a light-emitting surface connected to the incident surface, the edge-lit backlight source 1 facing the incident surface; a backplane 3; a mold frame 4 and a front frame 5. A heat-dissipation layer 6 is disposed on an outer surface of the front frame 5 near the edge-lit backlight source 1.

In the instant embodiment, the heat-dissipation layer 6 is a radiation heat-dissipation material layer. In other words, a radiation heat-dissipation material layer is coated on the outer surface of the front frame 5 near the edge-lit backlight source 1. The radiation heat-dissipation material layer is a material able to dissipate heat through radiation, and usually has the features of higher reflectance for visible light and near-infrared light, higher thermal transmittance for infrared and stability, as well as, better physical and chemical properties and better workability. The radiation heat-dissipation material usually uses infrared of 8-13.5 um wavelength to radiate the heat on surface of the coated object, and can withstand the temperature up to 600° C.

For further improvement, the radiation heat-dissipation material layer can be deposited with material having higher thermal conductivity and radiation, such as carbon nanotubes, to increase the thermal conductivity. The surface of the heat-dissipation layer shows the nano material, which appears smooth at a macro level and rough at a micro level, to increase the contact area between the heat-dissipation layer and the outside, and reduce the heat mask to greatly improve the heat-dissipation effect. Also, the radiation heat-dissipation material layer can be deposited with electronic transitions spinel as compound infrared radiation body to increase the impurity capability level and infrared radiation as well as maintain corresponding superior features, such as, thermal stability, heat-resistance, high strength, erosion resistance, abrasion resistance, and so on. Furthermore, to enhance the overall strength and stability of the heat-dissipation layer, heat-dissipation layer can also be deposited with rare earth oxide. One or any combination of the carbon nanotubes, electronic transitions spinel and rare earth oxide can be added to the radiation heat-dissipation material of the present embodiment.

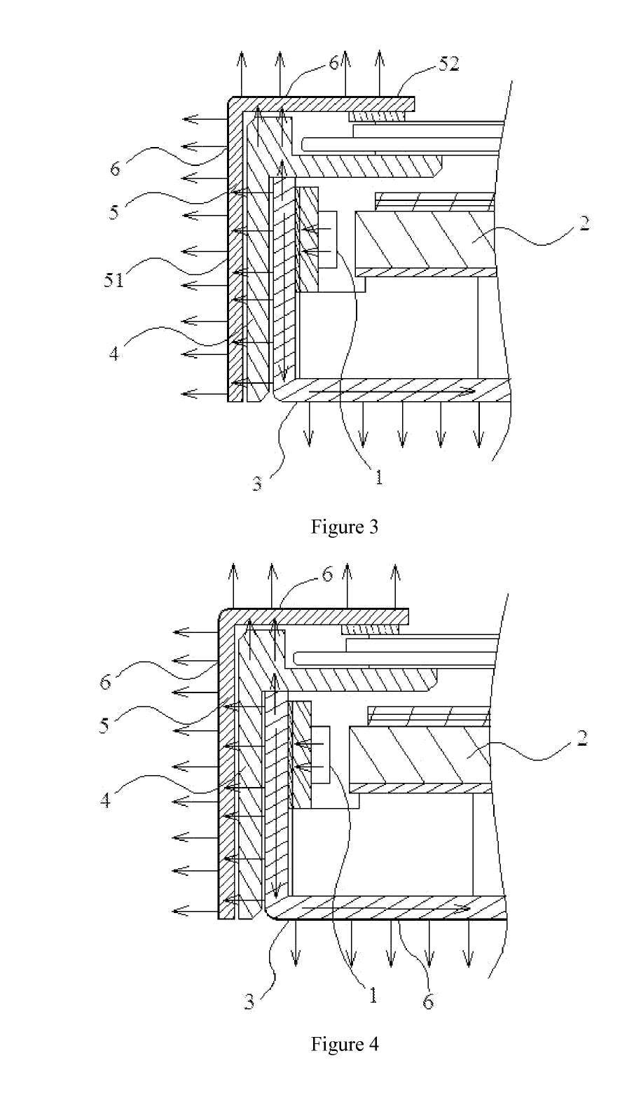

The radiation heat-dissipation material is usually in the state of high-performance heat-dissipation solution, such as heat-dissipation paint. When applied, the radiation heat-dissipation material can be coated directly onto the outer surface of the front frame 5 near the edge-lit backlight source 1 to form heat-dissipation layer 6. The heat-dissipation path of the liquid crystal module of the present embodiment is shown in FIG. 3, with the arrow indicating the heat-dissipation direction. During operation, the heat generated by the edge-lit backlight source 1 is conducted to the backplane 3, which is usually made of metal with better heat-dissipation capability, such as aluminum. The heat is conducted upwards, downwards and towards left, wherein the heat path towards left and upwards reaches the front frame 5 through the mold frame 4, and the head path downwards reaches the backplane 3. Because the heat-dissipation layer 6 is disposed on the outer surface of the front frame 5 near the edge-lit backlight source 1, specifically, the heat-dissipation layer 6 is disposed on the left surface 51 and top surface 52 of the front frame 5 in FIG. 3, the heated conducted through the mold frame 4 will be radiated outwards to reduce the surface temperature and internal temperature of the front frame 5. Compared to the know technique which only dissipates heat through the front frame 5, the heat-dissipation capability of the present embodiment is greatly improved. It should be noted that while the light enters from the left in FIG. 3, the present invention is also applicable to other embodiments with life entering from the right as long as the heat-dissipation layer 6 is disposed on the outer surface of the front frame 5 near the edge-lit backlight source 1. The outer surface of the front frame 5 comprises a first surface parallel to the incident surface of the light-guiding plate 2, and a second surface perpendicular to the incident surface of the light-guiding plate 2. In FIG. 3, the left surface 51 is the first surface and the top surface 52 is the second surface.

The heat-dissipation layer 6 of the present embodiment can also be a soft ceramic heat-dissipation paint. The a soft ceramic heat-dissipation paint can reflect the heat source and reduce the thermal resistance, as well as seep through slits and stay soft so as to effectively prevent the humidity form seeping. The anti-static electricity feature prevents the dust from sticking to the surface. The material is lead-free, halogen-free, non-toxic and organic decomposable material.

As shown in FIG. 3, the backplane 3 also dissipates some of the heat from the bottom. Therefore, for further improvement, as shown in FIG. 4, the heat-dissipation layer 6 can also be disposed at bottom of the backplane 3, i.e, coated with a layer of radiation heat-dissipation material. As such, the heat on the bottom surface of the backplane 3 can also be dissipated outward in radiation manner to enhance the heat-dissipation capability of the backplane 3.

In the present embodiment, based on the heat generation amount of the edge-lit backlight source 1, the heat-dissipation layer 6 has a thickness of 0.02-0.06 mm.

Accordingly, the second embodiment of the present invention provides a liquid crystal display device, which comprises a liquid crystal module provided in the first embodiment of the present invention.

Because the heat-dissipation capability is closed related to the material, the front frame in the know technique is limited by the material so that the heat-dissipation result through conduction is poor. The liquid crystal module and the liquid crystal display device of the present invention disposes a heat-dissipation layer formed by radiation heat-dissipation material on the outer surface of the front frame near the edge-lit backlight source and uses the radiation heat-dissipation to greatly enhance the heat-dissipation capability of the front frame and improve the overall heat-dissipation result of the liquid crystal module and the liquid crystal display device. By disposing heat-dissipation layer formed by radiation heat-dissipation material on the bottom of the backplane, the radiation result is further enhanced over the relatively good heat-dissipation capability so that the heat-dissipation effect becomes more obvious.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A liquid crystal module, which comprises: an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source.

2. The liquid crystal module as claimed in claim 1, characterized in that the outer surface of the front frame comprises a first surface parallel to the incident surface of the light-guiding plate, and a second surface perpendicular to the incident surface of the light-guiding plate.

3. The liquid crystal module as claimed in claim 2, characterized in that the heat-dissipation layer is a radiation heat-dissipation material layer.

4. The liquid crystal module as claimed in claim 3, characterized in that the heat-dissipation layer has a thickness of 0.02-0.06 mm.

5. The liquid crystal module as claimed in claim 4, characterized in that the backplane is disposed with a heat-dissipation layer at bottom.

6. The liquid crystal module as claimed in claim 3, characterized in that the radiation heat-dissipation material layer is deposited with one or any combination of carbon nanotubes, electronic transitions spinel, and rare earth oxide.

7. The liquid crystal module as claimed in claim 3, characterized in that the radiation heat-dissipation material layer is a heat-dissipation paint.

8. The liquid crystal module as claimed in claim 7, characterized in that the heat-dissipation paint is a soft ceramic heat-dissipation paint.

9. A liquid crystal display device, which comprises: a liquid crystal module, the liquid crystal module further comprising: an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source.

10. A liquid crystal display device, which comprises: a liquid crystal module, the liquid crystal module further comprising: an edge-lit backlight source, a light-guiding plate, a backplane, a mold frame and a front frame; the light-guiding plate having an incident surface and a light-emitting surface connected to the incident surface; the edge-lit backlight source facing the incident surface; wherein a heat-dissipation layer being disposed on an outer surface of the front frame near the edge-lit backlight source.

11. The liquid crystal display device as claimed in claim 10, characterized in that the outer surface of the front frame comprises a first surface parallel to the incident surface of the light-guiding plate, and a second surface perpendicular to the incident surface of the light-guiding plate.

12. The liquid crystal display device as claimed in claim 11, characterized in that the heat-dissipation layer is a radiation heat-dissipation material layer.

13. The liquid crystal display device as claimed in claim 12, characterized in that the heat-dissipation layer has a thickness of 0.02-0.06 mm.

14. The liquid crystal display device as claimed in claim 13, characterized in that the backplane is disposed with a heat-dissipation layer at bottom.

15. The liquid crystal display device as claimed in claim 12, characterized in that the radiation heat-dissipation material layer is deposited with one or any combination of carbon nanotubes, electronic transitions spinel, and rare earth oxide.

16. The liquid crystal display device as claimed in claim 12, characterized in that the radiation heat-dissipation material layer is a heat-dissipation paint.

17. The liquid crystal display device as claimed in claim 16, characterized in that the heat-dissipation paint is a soft ceramic heat-dissipation paint.
